(19) United States
(12) Patent Application Publication
(10) Pub. No.: US 2004/0183322 A1
(43) Pub. Date: Sep. 23, 2004

(54) Armored tank

(76) Inventors: Rudiger Baus, Vellmar (DE); Helmut Jahn, Kaufungen (DE); Martin Gerken, Kassel (DE); Michael Pfennig, Kassel (DE); Eugen Schlegl, Grubenzell (DE)

Correspondence Address: Robert W Becker & Associates, Suite B, 707 Highway 66 East, Tijeras, NM, 87059, US

(21) Appl. No.: 10/480,065

(22) PCT Filed: May 29, 2002
(86) PCT No.: PCT/DE02/01970

(30) Foreign Application Priority Data
Jun. 8, 2001 (DE) 101 27 742.3

(51) Int. Cl. B60N 3/00

(52) U.S. Cl. 296/24.4

(57) ABSTRACT

An armored tank is provided and has a weapons station disposed on the roof of a vehicle housing that is carried by a tracked drive. The interior of the housing is divided into three regions, namely a front region, in which are disposed the drive mechanism and the driver's seat, a rear region in which are disposed seats for the crew, and a middle region that is usable for various purposes depending upon the layout of the tank, especially for accommodating a turret platform and/or at least one seat for operators of the weapons station and/or storage space for munitions and munitions delivery mechanisms.

The invention relates to an armored tank having a vehicle housing that is carried by a tracked drive, and a weapons station that is disposed on the roof of the vehicle housing.

The object of the invention is to embody such an armored tank in such a way that with the same vehicle housing, different vehicle variants having a mission-specific layout can be constructed.

The realization of this object in inventively effected in that the interior of the vehicle housing is divided into three regions, namely a front region, in which are disposed the drive mechanism and the driver seat, a rear region, in which are disposed the seats for the crew, and a middle region which, depending upon the layout of the vehicle, is usable for various purposes, in particular for the accommodation of a turret platform and/or at least one seat for operators of the weapons station and/or storage space for munitions and munitions supply mechanisms. Pursuant to one particularly advantageous embodiment of the armored tank, pursuant to the further invention the overall vehicle is composed of individual modules, namely a basic module that contains the vehicle housing, a drive module, and further modules that enable the construction of different layout variants having different weights. In so doing, it is possible to selectively place upon the same vehicle housing a manned turret, in particular a turret having a turret platform disposed in the middle region of the interior of the vehicle housing, or an unmanned turret.

The main concept of the invention is to basically divide the interior of the vehicle housing into three regions, whereby two of these regions have the same function for all vehicle variants in that the drive mechanism and the driver's seat are disposed in the front region, whereas in the rear region the seats for the crew are provided. The third, middle region is then available for very different purposes.

A further main concept of the invention is that the overall vehicle is to be composed of individual modules. The weight proportion of the combat weight characterized by these layout variants can be up to 50% of the overall weight. This permits vehicle variants from a light infantry vehicle to heavily armored tanks. This construction has the further advantage that by removing individual modules of the overall construction, the combat weight of the vehicle can be reduced to such an extent that an air transport or shipment is possible.

Embodiments for the inventive armored tank will be described in greater detail in the following with the aid of the accompanying drawings.

The drawings show:

FIG. 1 a side view of an armored tank;

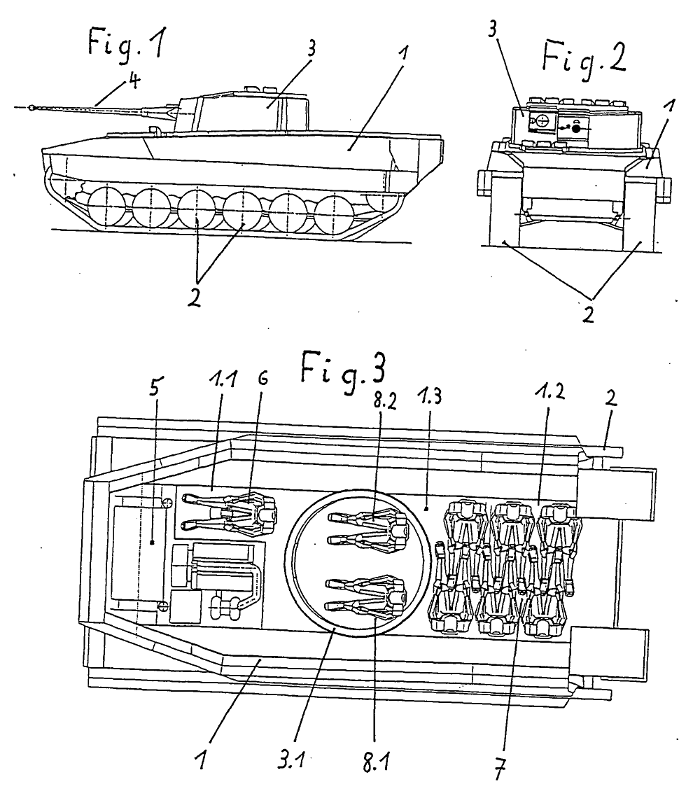

FIG. 2 a front view of the armored tank of FIG. 1;

FIG. 3 the armored tank of FIG. 1 in a view from above, with the turret removed and the roof plate taken off;

FIG. 4 an exploded view of the armored tank with a series of protective modules secured thereon;

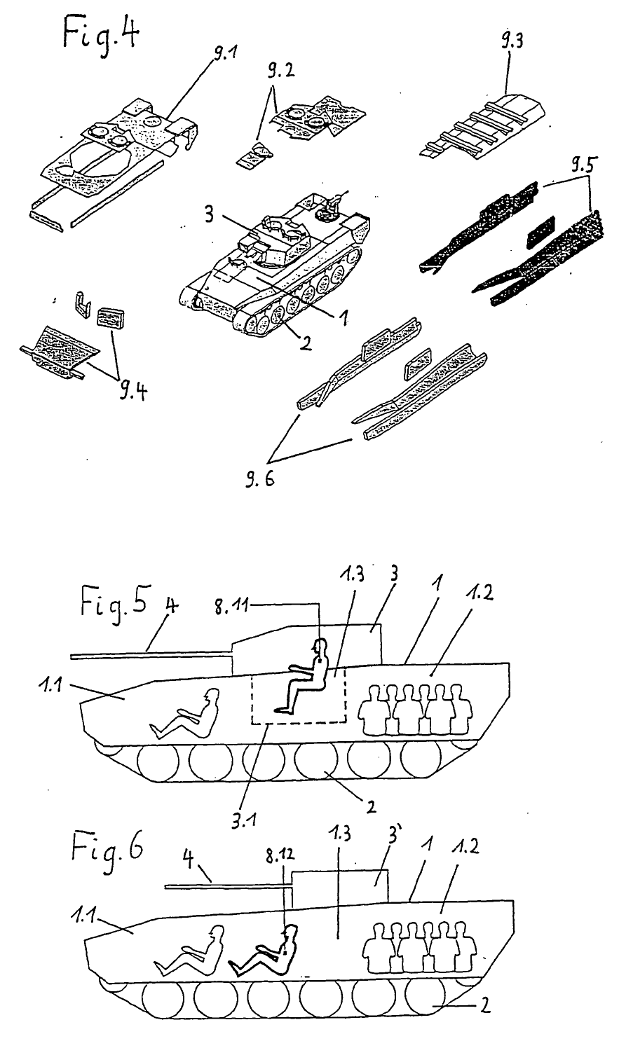

FIGS. 5 and 6 very schematically illustrated variants of the armored tanks with various turrets and various arrangements of the operating spaces of the weapons station;

FIGS. 7 to 9 in an illustration analogous to FIG. 5, various variants of the armored tank with different arrangements of the munitions and the munitions feed devices.

FIGS. 1 to 3 show an armored tank having a vehicle housing 1, which is carried by a tracked drive 2, and a turret 3 that is disposed on the roof of the vehicle housing and has a weapon 4.

The interior of the compact vehicle housing 1 is divided into three regions. Disposed in a front region 1.1 is a drive mechanism 5 as well as a driver's seat 6. The drive mechanism 5 can either be a diesel electric drive or a conventional motor/transmission unit. Disposed in the rear region 1.2 of the interior of the vehicle housing 1 are the seats 7 for the crew. The middle region 1.3 of the interior is available for various purposes depending upon the layout of the vehicle. In the embodiment of FIGS. 1 to 3, which is also the basis for FIGS. 5 and 7, a manned turret 3 is placed upon the vehicle housing 1, the turret platform 3.1 of which takes up at least a portion of the middle region 1.3 of the interior. Two operator seats 8.1 and 8.2 are disposed in the turret.

The construction of the vehicle with the compact vehicle housing 1 as the base module additionally offers the possibility of providing a straightforward interface between the vehicle housing 1 and the drive 2, which can be uncoupled, so that if necessary, differently embodied drives can be combined with the same vehicle housing 1. This ensures that of the overall vehicle concept, with altered requirements even particularly heavy variants can be derived with which the maximum ground pressure is not exceeded.

Furthermore, various protective modules can be secured on and/or onto the same vehicle housing 1. This is illustrated in FIG. 4. On the surface of the vehicle housing 1, a basic protective module 9.1 can first be secured in the regions front, side, rear and roof. Furthermore, passive or reactive roof protective modules 9.2 can be secured on the vehicle housing 1, including the turret 3. A mine protective module 9.3 can be secured to the underside of the vehicle housing 1. However, this mine protective module can also be integrated into the uncoupled drive 2. In this way, it is uncoupled from the vehicle housing. HL protective modules and/or KE protective modules 9.4 can be secured to the front side of the vehicle housing 1. Similarly, HL protective modules 9.5 and/or KE protective modules 9.6 can be secured to the sides of the vehicle housing 1.

All of the protective modules, can, in principle, be constructed as individual, undivided modules or as divided modules, and they can be embodied in various technologies, and in particular passively, reactively, actively/reactively.

The vehicle housing 1 is furthermore embodied in such a way that various weapon concepts can be integrated. For example, as already mentioned, and for example as also illustrated in FIGS. 5 and 7, a manned turret 3 can be placed on the housing and has at least one operator seat 8.11, whereby for example pursuant to FIG. 7 the munitions and the munitions delivery mechanism 10.1 are disposed below the roof plate of the vehicle housing 1 in the region of the turret platform 3.1.

As can be seen from FIG. 8, with a manned turret 3″ having at least one operator seat 8.13, munitions and munitions feed mechanism 10.2 can also be disposed above the turret platform 3.1″ or the roof plate of the vehicle housing 1 in the rear of the turret.

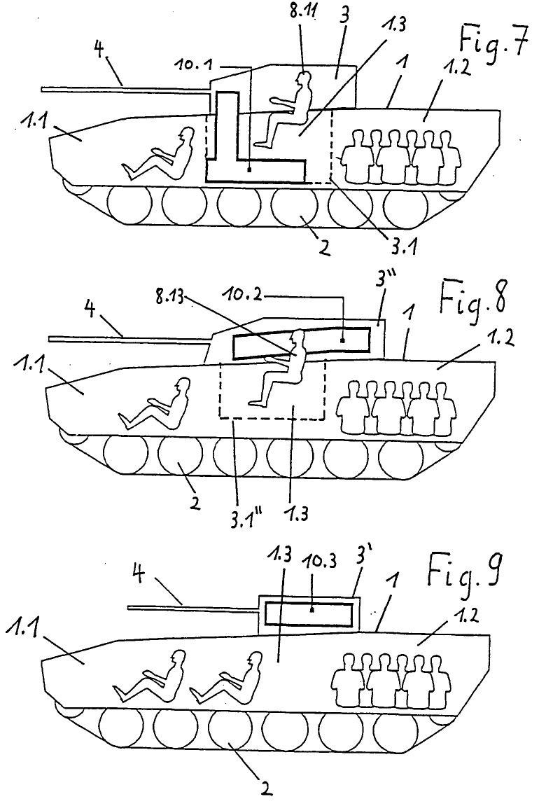

Furthermore, as illustrated in FIGS. 6 and 9, a weapons station embodied as an unmanned turret 3′ can be placed upon the vehicle housing 1, with at least one operator seat 8.12 being disposed in the interior of the vehicle housing, and the storage of munitions and munitions feed mechanism 10.3 can then be above the roof plate of the vehicle housing 1 directly at the weapon 4. Thus, depending upon the weapons concept, various operating concepts are possible by accommodating the operator or operators either in the turret or in the vehicle housing, for which purpose, in both cases, the middle region 1.3 of the interior is provided.

As a consequence of the above explained modular configuration of the basic tank, various grades of protection and vehicle weights can be represented. By adding individual protective modules, the level of protection of the vehicle can be increased. The vehicle then has protection all the way around against medium heavy threats.

1. Armored tank having a vehicle housing (1) carried by a tracked drive (2), and a weapons station (34) disposed on the roof of the vehicle housing, whereby the interior of the vehicle housing (1) is divided into three regions, namely a front region (1.1), in which are disposed the drive mechanism (5) and the driver's seat (6), a rear region (1.2), in which are disposed the seats (7) for the crew, and a middle region (1.3) that is usable for various purposes depending upon the layout of the vehicle, especially for the accommodation of a turret platform (3.1) and/or at least one seat (8.1, 8.2, 8.11, 8.12) for operators of the weapons station and/or storage room for munitions and munitions feed devices (10.1, 10.2, 10.3).

2. Armored tank according to claim 1, characterized in that the overall vehicle is composed of individual modules, namely a base module that contains the vehicle housing (1), a drive module (2), and further modules (3.3′, 3″, 9.1-9.6) that enable the construction of various layout variants having different weights.

3. Armored tank according to claim 2, characterized in that selectively a manned turret (3, 3″), especially a turret (3) having a turret platform (3.1) disposed in the middle region (1.3) of the interior of the vehicle housing (1), or an unmanned turret (3′) can be placed upon the same vehicle housing (1).

4. Armored tank according to claim 2 or 3, characterized in that various protective modules (9.1-9.5) of the armor can be secured on and/or to the same vehicle housing (1).

5. Armored tank according to claim 4, characterized in that basic protective modules (9.1) can be secured to the surface of the vehicle housing (1) in the front, side, rear and roof regions.

6. Armored tank according to claim 4 or 5, characterized in that at least one roof protective module (9.2) can be secured to the vehicle housing (1).

7. Armored tank according to one of the claims 4-6, characterized in that a mine protective module (9.3) can be secured to the underside of the vehicle housing (1).

8. Armored tank according to one of the claims 4-6, characterized in that the tracked drive (2) can be removably secured to the vehicle housing (1) and a mine protective module (9.3) can be secured to the tracked drive.

9. Armored tank according to one of the claims 4-8, characterized in that at least one HL protective module and/or one KE protective module (9.4) can be secured to the front side of the vehicle housing (1).

10. Armored tank according to one of the claims 4-9, characterized in that HL protective modules (9.5) and/or KE protective modules (9.6) can be secured to the sides of the vehicle housing (1).

11. Armored tank according to one of the claims 1-10, characterized in that munitions and munitions delivery mechanisms (10.1) are disposed below the roof plate of the vehicle housing (1) in the region of the turret platform (3.1).

12. Armored tank according to one of the claims 1-10, characterized in that munitions and munitions delivery mechanisms (10.2) are disposed above the roof plate of the housing (1) in the rear of the turret.

13. An armored tank according to one of the claims 1-10, characterized in that with an unmanned turret (3′), munitions and munitions delivery mechanisms (10.3) are disposed above the roof plate of the vehicle housing (1) directly on the main weapon (4).
